(19) United States
(12) Patent Application Publication
(10) Pub. No.: US 2006/0268174 A1
(43) Pub. Date: Nov. 30, 2006

(54) Video signal processing apparatus and method of detecting a difference in gradation level

(75) Inventors: Eiki Obara, Hiki-gun (JP); Tatsuo Yamaguchi, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/368,109

(22) Filed: Mar. 3, 2006

(30) Foreign Application Priority Data
May 12, 2005 (JP) 2005-139877

(51) Int. Cl. H04N 5/14

(52) U.S. Cl. 348/571

(57) ABSTRACT

According to one embodiment, a horizontal detection circuit detects a fixed range within which a difference between pixel values of signals output from a horizontal HPF circuit falls, as a horizontal flat area, and obtains a boundary in the horizontal direction in the detected area. When a difference between pixel values before and after the boundary or a degree of variation therebetween falls within a prescribed range, the horizontal detection circuit detects the boundary as a difference in level in a gradation area. A vertical detection circuit detects a vertical flat area from signals output from a vertical HPF circuit, and obtains a boundary in the vertical direction in the detected area. When a difference between pixel values before and after the boundary or a degree of variation therebetween falls within a prescribed range, the vertical detection circuit detects the boundary as a difference in level in a gradation area.

### CROSS-REFERENCE TO RELATED APPLICATIONS

This application is based upon and claims the benefit of priority from Japanese Patent Application No. 2005-139877, filed May 12, 2005, the entire contents of which are incorporated herein by reference.

### BACKGROUND

1. Field

One embodiment of the invention relates to a video signal processing apparatus that processes video signals digitally. More specifically, the invention relates to a method of detecting a difference in level between stripes, which is caused in a gradation area in a displayed image due to the roughness of quantization of video signals, in order to cancel the stripes.

2. Description of the Related Art

Conventional video signal processing apparatuses (commonly called graphic boards) of personal computers (referred to as PC hereinafter) chiefly process video signals with an 8-bit gradation and finally convert the 8-bit gradation signals into 6-bit gradation signals. The apparatuses subject the signals to a so-called dithering process with the subtracted two bits and output them to a display. An 8-bit gradation is thus achieved. Conventional video signal processing apparatuses of digital television receivers (referred to TV hereinafter) process video signals with a 10-bit gradation and finally convert the 10-bit gradation signals into 8-bit gradation signals. The apparatuses subject the signals to a dithering process (commonly called frame rate control (FRC)) called magic square algorithm with the subtracted two bits, and output them to a display. A 10-bit gradation is thus achieved.

It is disclosed by, for example, in the above conventional video signal processing apparatuses, though the roughness of quantization of video signals is lessened by the dithering process, a difference in level between quantization bits is conspicuous in a gradation area in which tones vary gradually and accordingly stripes are displayed therein.

As an example of a technique related to the present invention, Jpn. Pat. Appln. KOKAI Publication No. 2002-108298 discloses a method of processing digital signals. In this method, correction data for brightness inconsistencies caused on video images on a screen is stored in advance for each of correction points by which the screen is divided at regular intervals in the horizontal and vertical directions, and video signals are subjected to nonlinear interpolation using the correction data, thereby adding the correction data to digital data. However, the technique proposed in the Publication is directed to a process of correcting brightness inconsistencies and not used to cancel a difference in level in a gradation area due to the roughness of quantization of the video signals.

As described above, in the conventional video signal processing apparatuses of PC and TV, the roughness of quantization of video signals is lessened by the dithering, but a difference in level between quantization bits is conspicuous in the gradation area in which tones vary gradually and accordingly stripes are displayed therein.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a configuration of a TV-receiving-capable notebook personal computer according to a first embodiment of the present invention;

FIG. 2 is a block diagram of the entire configuration of the TV-receiving-capable notebook personal computer according to the first embodiment;

FIG. 3 is a block diagram specifically showing an arrangement of a gradation processing circuit of the notebook personal computer according to the first embodiment;

FIG. 4 is a flowchart of algorithm for detecting a difference in horizontal-direction gradation level by software in the gradation processing circuit shown in FIG. 3;

FIG. 5 is a flowchart of algorithm subsequent to the algorithm shown in FIG. 4;

FIG. 6 is a flowchart of algorithm for detecting a difference in vertical-direction gradation level by software in the gradation processing circuit shown in FIG. 3;

FIG. 7 is a flowchart of algorithm subsequent to the algorithm shown in FIG. 6;

FIG. 8 is a conceptual diagram illustrating an interpolation process performed by a horizontal/vertical boundary gradation interpolation circuit of the gradation processing circuit shown in FIG. 3;

FIG. 9 is a schematic diagram illustrating the interpolation process performed by the horizontal/vertical boundary gradation interpolation circuit according to the first embodiment;

FIG. 10 is a block diagram showing a configuration obtained when the present invention is applied to a television receiver according to the first embodiment; and

FIG. 11 is a block diagram specifically showing an arrangement of a gradation processing circuit according to a second embodiment of the invention.

### DETAILED DESCRIPTION

Various embodiments according to the invention will be described hereinafter with reference to the accompanying drawings. In general, according to one embodiment of the invention, a video signal processing apparatus comprises a horizontal-direction processing unit which processes a frame image of a quantized video signal in a horizontal direction, and a vertical-direction processing unit which processes the frame image of the quantized video signal in a vertical direction, the horizontal-direction processing unit including horizontal filter means for receiving adjacent pixels in the horizontal direction of the frame image in sequence and outputting the pixels, first area detection means for detecting an area in a fixed range within which values of the pixels output from the horizontal filter means fall, first determination means for determining that a boundary in the horizontal direction is a difference in level in a gradation area when the values of the pixels output from the horizontal filter means fall within a prescribed range in the area detected by the first area detection means, and first gradation correction means for correcting gradation before and after the boundary in the horizontal direction when the first determination means determines that the boundary is a difference in level in the gradation area, and the vertical-direction processing unit including vertical filter means for receiving adjacent pixels in the vertical direction of the frame image in sequence and outputting the pixels, second area detection means for detecting an area in a fixed range within which values of the pixels output from the vertical filter means fall, second determination means for determining that a boundary in the vertical direction is a difference in level in a gradation area when the values of the pixels output from the vertical filter means fall within a prescribed range in the area detected by the second area detection means, and second gradation correction means for correcting gradation before and after the boundary in the vertical direction when the second determination means determines that the boundary is a difference in level in the gradation area.

According to another aspect of the present invention, there is provided a method of detecting a difference in gradation level, which is applied to a video signal processing apparatus which performs horizontal-direction image processing for processing a frame image of a quantized video signal in a horizontal direction and vertical-direction image processing for processing a frame image of a quantized video signal in a vertical direction, the horizontal-direction image processing comprising, a horizontal filter processing step of receiving adjacent pixels in the horizontal direction of the frame image in sequence and outputting the pixels, a first area detection step of detecting an area in a fixed range within which values of the output pixels of the horizontal filter processing step fall, and a first determination step of determining that a boundary in the horizontal direction is a difference in level in a gradation area when the values of the output pixels of the horizontal filter processing step fall within a prescribed range in the area detected in the first area detection step, and the vertical-direction image processing including a vertical filter processing step of receiving adjacent pixels in the vertical direction of the frame image in sequence and outputting the pixels, a second area detection step of detecting an area in a fixed range within which values of the output pixels of the vertical filter processing step fall, and a second determination step of determining that a boundary in the vertical direction is a difference in level in a gradation area when the values of the output pixels of the vertical filter processing step fall within a prescribed range in the area detected in the second area detection step.

According to the invention described above, there can be provided a video signal processing apparatus that detects a difference in level between stripes, which is caused in a gradation area in a displayed image due to the roughness of quantization of video signals, in order to cancel the stripes, and a method of doing the same.

### First Embodiment

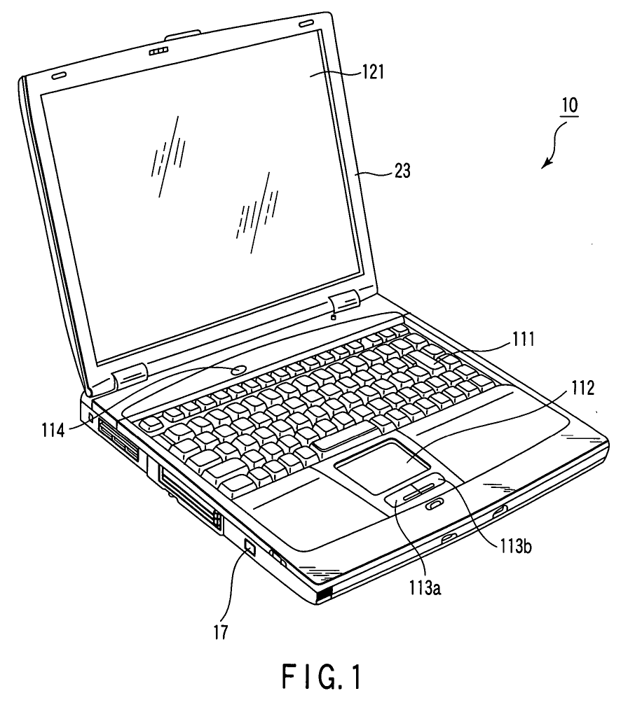

FIG. 1 is a diagram showing a configuration of a TV-receiving-capable notebook personal computer according to a first embodiment of the present invention.

As shown in FIG. 1, a computer 10 includes a main body and a display unit 23. The display unit 23 incorporates a liquid crystal display (LCD) device. The display screen 121 of the LCD device is located in almost the central part of the display unit 23.

The display unit 23 is attached to the main body rotatably between an opened position and a closed position. The main body has a thin box-shaped housing. A power button 114 and a keyboard 111 are arranged on the top of the housing. A touch pad 112, right and left two buttons 113a and 113b and an optical disk drive 17 are arranged on a palm rest of the housing.

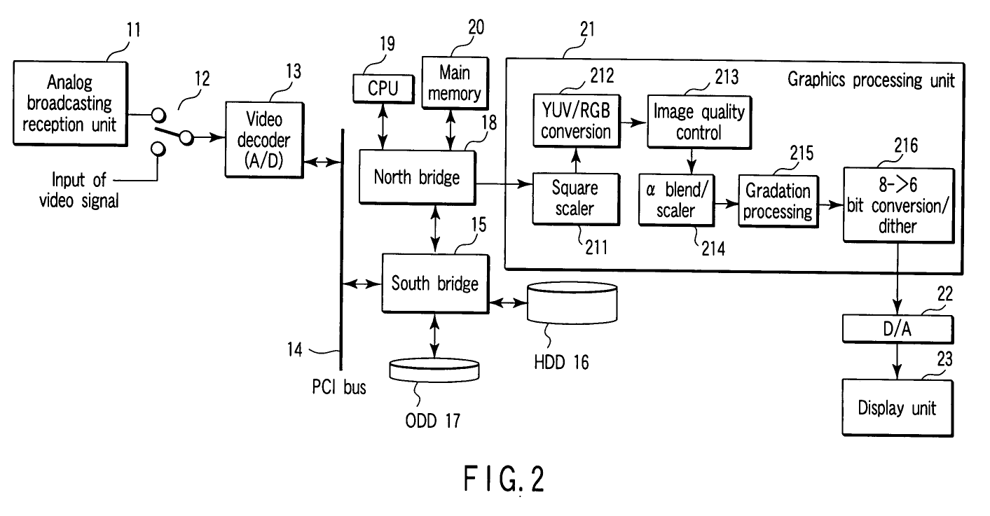

FIG. 2 is a block diagram of the entire configuration of the TV-receiving-capable notebook personal computer.

Referring to FIG. 2, a TV receiving unit 11 receives a user's designated channel program, demodulates a TV signal of the program, and divides it into a video signal and a sound signal. The video signal is sent to a video decoder 13 through a switch 12. The switch 12 selects a TV video signal and a video signal supplied from another video playback apparatus (e.g., a DVD player).

The video decoder 13 converts an input video signal into a baseband signal (YUV) and digitizes it. The video signal is represented with an 8-bit gradation. This digital video signal is sent to a south bridge 15 via a PCI bus 14. The south bridge 15 contains a hard disk drive (HDD) 16 and an optical disk drive (ODD) 17 and writes/reads data to/from the recording mediums of the drives in response to control instructions. The south bridge 15 is connected to a north bridge 18. The north bridge 18 processes data of the south bridge 15 using software executed by a central processing unit (CPU) 19 and a main memory 20. In other words, the video signal input to the south bridge is sent to the north bridge 18 in response to a control instruction from the north bridge 18, and its image is processed by software and then supplied to a graphics processing unit 21.

The graphics processing unit 21 includes a square scaler circuit 211, a YUV/RGB conversion circuit 212, an image quality control circuit 213, an a blend/scaler circuit 214, a gradation processing circuit 215, and a bit conversion/dither circuit 216. The square scaler circuit 211 adjusts the pixels of the input video signal. The YUV/RGB conversion circuit 212 converts the format of the signal. The image quality control circuit 213 controls the balance of image quality. The α blend/scaler circuit 214 changes the image size according to the display size. Then, the gradation processing circuit 215 corrects the gradation of the image as appropriate. The bit conversion/dither circuit 216 changes the data size of the video signal output from the circuit 215 into six bits and subjects it to dithering. This signal is sent to the display unit 23 via a D/A conversion unit 22.

As in the prior art, the above graphics processing unit 21 processes an 8-bit video signal and converts it into a 6-bit output video signal. The output video signal is subjected to dithering with the subtracted two bits and represented as an 8-bit gradation. Though the 8-bit gradation is a pseudo one, the largest gradation actually corresponds to eight bits of each of R, G and B. At this time, there occurs a difference in level between stripes in a gradation area in a displayed image due to the roughness of quantization of the video signal. In the first embodiment of the present invention, the gradation processing circuit 215 detects the difference in level and makes an appropriate correction to make the difference inconspicuous.

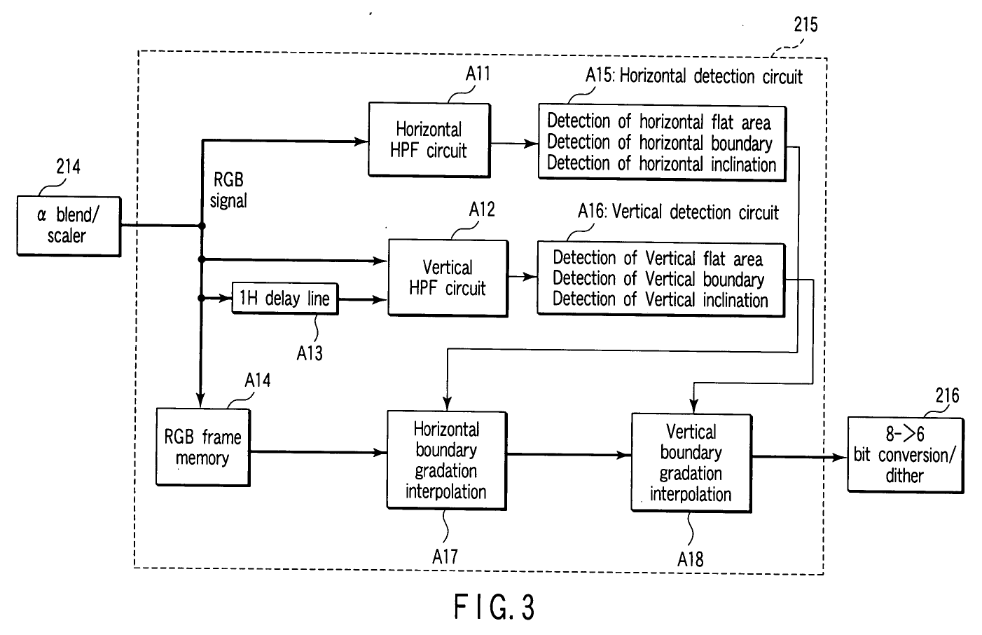

FIG. 3 is a block diagram specifically showing an arrangement of the gradation processing circuit 215. In FIG. 3, it is three R, G and B video signals that are input to the circuit 215. For the sake of brevity, assume here that the R, G and B signals are processed as one RGB signal.

Referring to FIG. 3, the RGB signal output from the a blend/scaler circuit 214 is input to a horizontal high-pass filter (HPF) circuit (horizontal filter means) A11, a vertical high-pass filter (HPF) circuit (vertical filter means) A12, a 1H delay line A13 and an RGB frame memory circuit A14.

The RGB signal input to the horizontal HPF circuit A11 is supplied to a horizontal detection circuit A15.

In response to the RGB signal, the horizontal detection circuit A15 detects a horizontal flat area, a horizontal boundary and a horizontal inclination. More specifically, the circuit A15 detects as the horizontal flat area (gradation area) a fixed range within which the pixel value of the output of the horizontal HPF circuit falls, and obtains a boundary of the detected area in the horizontal direction. If the output of the horizontal HPF circuit falls within a prescribed range before and after the boundary, the circuit A15 determines the boundary in the horizontal direction as a difference in level in the gradation area. If the output falls outside the prescribed range, the circuit A15 determines it as the boundary of another area.

The RGB signal input to the vertical HPF circuit A12 is supplied to a vertical detection circuit A16.

In response to the RGB signal, the vertical detection circuit A16 detects a vertical flat area, a vertical boundary and a vertical inclination. More specifically, the circuit A16 detects as the vertical flat area a fixed range within which the pixel value of the output of the vertical HPF circuit falls, and obtains a boundary of the detected area in the vertical direction. If the output of the vertical HPF circuit falls within a prescribed range before and after the boundary, the circuit A16 determines the boundary in the vertical direction as a difference in level in the gradation area. If the output falls outside the prescribed range, the circuit A16 determines it as the boundary of another area.

The RGB frame memory circuit A14 delays the input RGB signal by one frame to keep time for the above detection. The one-frame-delayed RGB signal is output from the gradation processing circuit 215 via a horizontal boundary gradation interpolation circuit A17 and a vertical boundary gradation interpolation circuit A18 and then supplied to the bit conversion/dither circuit 216.

When the horizontal detection circuit A15 determines that the boundary in the flat area is a difference in level in the gradation area, the circuit A17 subjects the signal to dithering before and after the boundary to make the difference in level inconspicuous. Similarly, when the vertical detection circuit A16 determines that the boundary in the flat area is a difference in level in the gradation area, the circuit A18 subjects the signal to dithering before and after the boundary to make the difference in level inconspicuous.

With the above processing, a difference in level (boundary) between stripes caused in the gradation area can be detected and distinguished from the boundary due to a pattern. The difference (boundary) can be corrected so that it becomes inconspicuous.

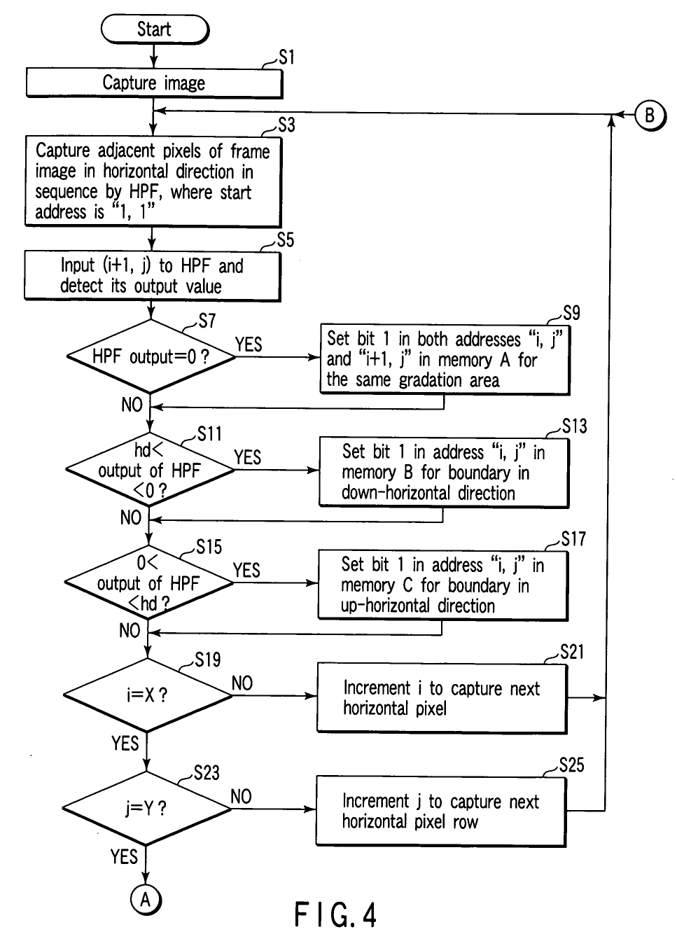

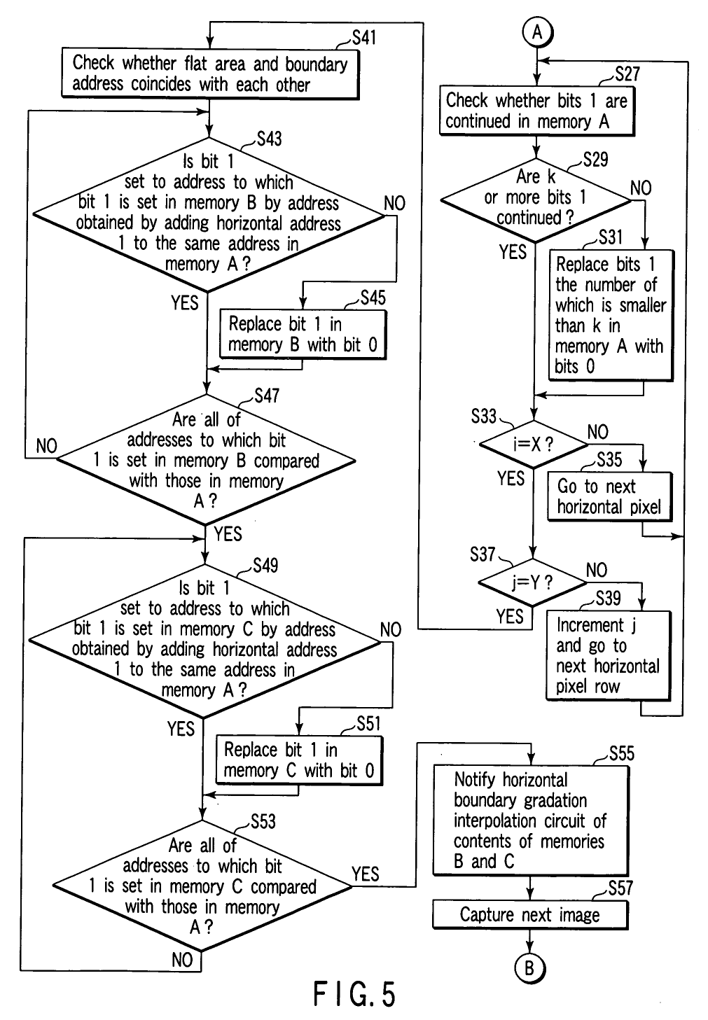

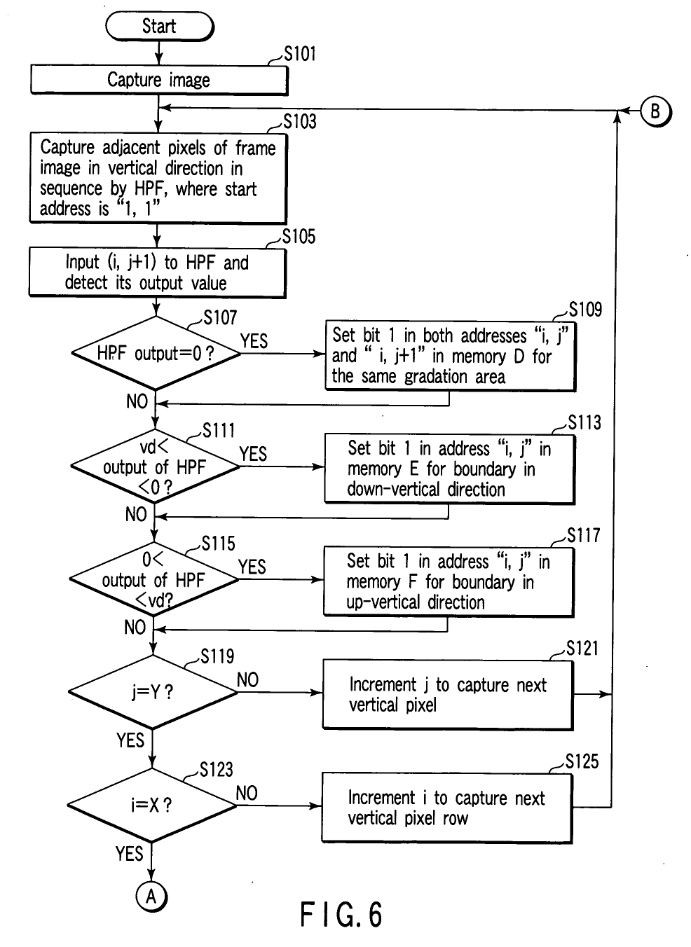

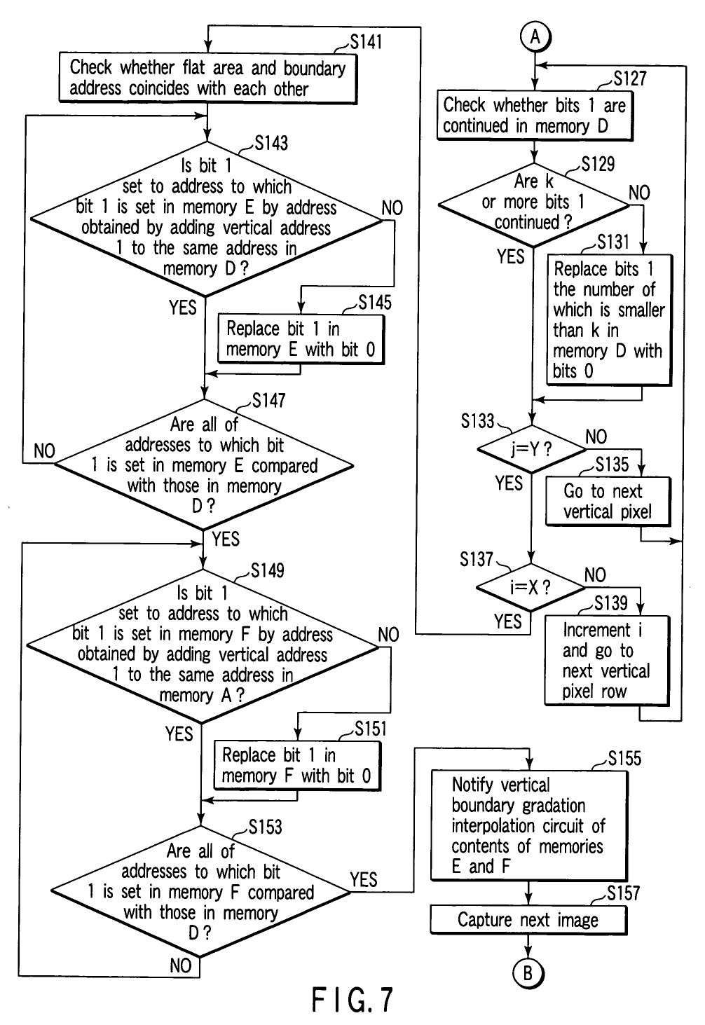

FIGS. 4 to 7 are flowcharts of algorithm used when the horizontal HPF circuit A11, horizontal detection circuit A15, vertical HPF circuit A12 and vertical detection circuit A16 in the gradation processing circuit 215 detect their respective gradation level differences by software. FIGS. 4 and 5 each show a process of detecting a gradation level difference in the horizontal direction, and FIGS. 6 and 7 each show a process of detecting a gradation level difference in the vertical direction.

The conditions for the above detecting processes are that the RGB frame memory circuit A14 stores image data and an image space is horizontal and vertical pixels X and Y. In the flowcharts of FIGS. 4 to 7, “i, j” indicates horizontal and vertical addresses, (i, j) denotes the pixel values of the addresses “i, j”, s is the number of gradation steps, A is a storage memory for the same-gradation area in the horizontal direction, B is a storage memory for a boundary in the down-horizontal direction, C is a storage memory for a boundary in the up-horizontal direction, D is a storage memory for the same-gradation area in the vertical direction, E is a storage memory for a boundary in the down-vertical direction, and F is a storage memory for a boundary in the up-vertical direction.

First of all, a process of detecting a gradation level difference in the horizontal direction will be described with reference to FIGS. 4 and 5.

When an image is captured in step S1, adjacent pixels of a frame image in the horizontal direction are captured by the horizontal HPF circuit A11. For example, (i, j) and (i+1, j) are captured. Assume here that the start pixel address is “1, 1”.

In step S5, (i+1, j) is input to the horizontal HPF circuit A11 and its value is detected. In step S7, it is determined whether the output of the HPF circuit A11 is zero (output of HPF=0). If NO, the flow advances to step S11. If YES, the flow advances to step S9. In step S9, bit 1 (bit=1) is set in both addresses “i, j” and “i+1, j” in the storage memory A of horizontal and vertical pixels X and Y corresponding to the image space secured for detecting the same gradation area. The flow goes to step S11.

In step S11, it is determined whether the output of the HPF circuit A11 is larger than hd and smaller than zero (hd<output of HPF<0). If NO, the flow advances to step S15. If YES, the flow advances to step S13. In step S13, bit 1 (bit=1) is set in address “i, j” in the storage memory B of horizontal and vertical pixels X and Y corresponding to the image space secured for detecting a boundary in the down-horizontal direction. The flow goes to step S15.

In step S15, it is determined whether the output of the HPF circuit A11 is larger than zero and smaller than hd (0<output of HPF<hd). If NO, the flow advances to step S19. If YES, the flow advances to step S17. In step S17, bit 1 (bit=1) is set in address “i, j” in the storage memory C of horizontal and vertical pixels X and Y corresponding to the image space secured for detecting a boundary in the up-horizontal direction. The flow goes to step S19.

In step S19, it is determined whether i is equal to X (i=X). If NO, i is incremented to capture the next horizontal pixel in step S21. The flow returns to step S3. If YES, it is determined whether j is equal to Y (j=Y) in step S23. If NO, j is incremented to capture the next horizontal pixel row in step S25. The flow returns to step S3.

If j is equal to Y (j=Y) (YES) in step S23, the flow goes to step S27 (FIG. 5). In step S27, it is checked whether bits 1 are continued in the memory A. In step S29, it is determined whether k or more bits 1 are continued or not. If they are continued (YES), the flow advances to step S33. If they are not (NO), the bits 1 the number of which is smaller than k are replaced with bits 0 in step S31. The flow goes to step S33.

In step S33, it is determined whether i is equal to X (i=X). If NO, the process goes to the next horizontal pixel in step S35. The flow returns to step S27. If YES, it is determined whether j is equal to Y (j=Y) in step S37. If NO, j is incremented to go to the next horizontal pixel row in step S39. The flow returns to step S27.

If j is equal to Y (j=Y) (YES) in step S37, the flow goes to step S41, in which it is checked whether a flat area and a boundary address coincides with each other. In step S43, it is determined whether bit 1 is set to the address to which bit 1 is set in the memory B by the address obtained by adding horizontal address 1 to the same address in the memory A. If bit 1 is set (YES), the flow advances to step S47. If it is not set (NO), bit 1 in the memory B is replaced with bit 0 in step S45. The flow advances to step S47. In step S47, it is determined whether all of addresses to which bit 1 is set in the memory B are compared with those in the memory A. If NO, the flow returns to step S43. If YES, the flow advances to step 49.

In step S49, it is determined whether bit 1 is set to the address to which bit 1 is set in the memory C by the address obtained by adding horizontal address 1 to the same address in the memory A. If bit 1 is set (YES), the flow advances to step S53. If it is not set (NO), bit 1 in the memory C is replaced with bit 0 in step S51. The flow advances to step S53. In step S53, it is determined whether all of addresses to which bit 1 is set in the memory C are compared with those in the memory A. If NO, the flow returns to step S49. If YES, the flow advances to step S55.

In step S55, the horizontal boundary gradation interpolation circuit A17 is notified of the contents of the memories B and C. In step S57, the next image is captured. The flow returns to step S3. Thus, the process of detecting a gradation level difference in the horizontal direction is completed.

Then, a process of detecting a gradation level difference in the vertical direction will be described with reference to FIGS. 6 and 7.

When an image is captured in step S101, adjacent pixels of a frame image in the vertical direction are captured by the vertical HPF circuit A12. For example, (i, j) and (i, j+1) are captured. Assume here that the start pixel address is “1, 1”. In step S5, (i, j+1) is input to the vertical HPF circuit A12 and its value is detected.

In step S107, it is determined whether the output of the HPF circuit A12 is zero (output of HPF=0). If NO, the flow advances to step S111. If YES, the flow advances to step S109. In step S109, bit 1 (bit=1) is set in both addresses “i, j” and “i, j+1” in the storage memory D of horizontal and vertical pixels X and Y corresponding to the image space secured for detecting the same gradation area. The flow goes to step S111.

In step S111, it is determined whether the output of the HPF circuit A12 is larger than vd and smaller than zero (vd<output of HPF<0). If NO, the flow advances to step S115. If YES, the flow advances to step S113. In step S113, bit 1 (bit=1) is set in address “i, j” in the storage memory E of horizontal and vertical pixels X and Y corresponding to the image space secured for detecting a boundary in the down-vertical direction. The flow goes to step S115.

In step S115, it is determined whether the output of the HPF circuit A12 is larger than zero and smaller than vd (0<output of HPF<vd). If NO, the flow advances to step S119. If YES, the flow advances to step S117. In step S117, bit 1 (bit=1) is set in address “i, j” in the storage memory F of horizontal and vertical pixels X and Y corresponding to the image space secured for detecting a boundary in the up-vertical direction. The flow goes to step S119.

In step S119, it is determined whether j is equal to Y (j=Y). If NO, j is incremented to capture the next vertical pixel in step S121. The flow returns to step S103. If YES, it is determined whether i is equal to X (i=X) in step S23. If NO, i is incremented to capture the next vertical pixel row in step S125. The flow returns to step S103.

If i is equal to X (i=X) (YES) in step S123, the flow goes to step S127 (FIG. 7). In step S127, it is checked whether bits 1 are continued in the memory D. In step S129, it is determined whether k or more bits 1 are continued or not. If they are continued (YES), the flow advances to step S133. If they are not (NO), the bits 1 the number of which is smaller than k are replaced with bits 0 in step S131. The flow goes to step S133.

In step S133, it is determined whether j is equal to Y (j=Y). If NO, the process goes to the next vertical pixel in step S135. The flow returns to step S27. If YES, it is determined whether i is equal to X (i=X) in step S137. If NO, i is incremented to go to the next vertical pixel row in step S139. The flow returns to step S127.

If i is equal to X (i=X) (YES) in step S137, the flow goes to step S141, in which it is checked whether a flat area and a boundary address coincides with each other. In step S143, it is determined whether bit 1 is set to the address to which bit 1 is set in the memory E by the address obtained by adding vertical address 1 to the same address in the memory D. If bit 1 is set (YES), the flow advances to step S147. If it is not set (NO), bit 1 in the memory E is replaced with bit 0 in step S145. The flow advances to step S147. In step S147, it is determined whether all of addresses to which bit 1 is set in the memory E are compared with those in the memory D. If NO, the flow returns to step S143. If YES, the flow advances to step 149.

In step S149, it is determined whether bit 1 is set to the address to which bit 1 is set in the memory F by the address obtained by adding vertical address 1 to the same address in the memory D. If bit 1 is set (YES), the flow advances to step S153. If it is not set (NO), bit 1 in the memory F is replaced with bit 0 in step S151. The flow advances to step S153. In step S153, it is determined whether all of addresses to which bit 1 is set in the memory F are compared with those in the memory D. If NO, the flow returns to step S149. If YES, the flow advances to step S155.

In step S155, the vertical boundary gradation interpolation circuit A18 is notified of the contents of the memories E and F. In step S157, the next image is captured. The flow returns to step S103. Thus, the process of detecting a gradation level difference in the vertical direction is completed.

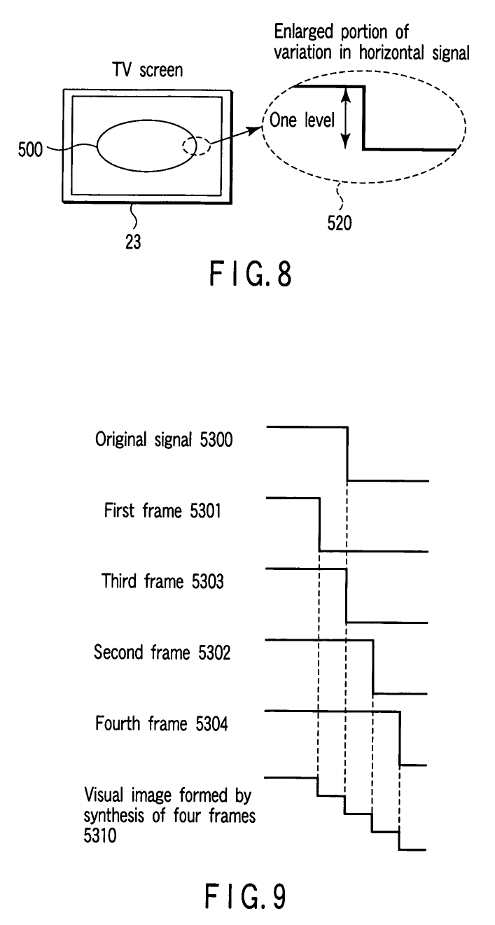

An interpolation process performed by each of the horizontal and vertical boundary gradation interpolation circuits A17 and A18 will be described with reference to FIGS. 8 and 9.

Assume now that an ellipse 500, which is slightly brighter than the background, is displayed in the central part of the screen of the display unit 23 as shown in FIG. 8. When the difference in brightness is one level ( 1/256 of dynamic range in the case of 8-bit quantization), if a flat portion of the boundary between bright and dark areas is enlarged (see 520 in FIG. 8), there is a difference in level in a signal corresponding to the flat portion. Since the position of the boundary and the inclination of brightness are detected by the horizontal detection circuit A15 as descried above with reference to FIG. 3, the boundary is subjected to dithering such that its position is changed for each frame (in FIG. 8 brightness is inclined to the dark area, or to the right from the left of the screen in the boundary).

As shown in FIG. 9, the position of the boundary is changed for each of the first to fourth frames with respect to the original signal, and a visual image of the synthesis of these four frames is formed, with the result that ¼-level fine gradation can be achieved. In this case, 8-bit signal processing is performed, but 10-bit signal processing can be done near the boundary. If such a process is applied to the entire boundary in the horizontal and vertical directions, stripes due to quantization can be made inconspicuous.

A personal computer including the gradation processing circuit 215 described above can detect a difference in level between stripes which occurs in a gradation area in a displayed image due to the roughness of quantization of video signals, and acquire a difference between pixel values in the boundary and inclination information of the boundary. Thus, the difference can be made inconspicuous by adequate gradation interpolation.

In the above first embodiment, gradation is processed by the RGB signal. Needless to say, the same advantages can be obtained even though the gradation can be done by a YUV signal.

In the above first embodiment, gradation is processed by the graphics processing 21. Needless to say, the same advantages can be obtained even though the gradation can be done by software implemented by the CPU 19, main memory 20 and north bridge 18.

### Second Embodiment

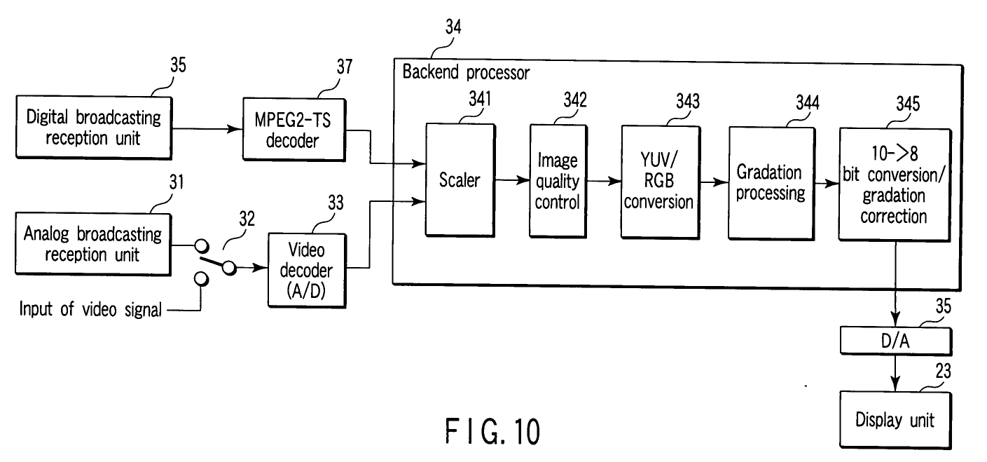

The present invention can be applied to a television receiver. FIG. 10 shows a configuration obtained when the present invention is applied to a television receiver.

As shown in FIG. 10, one of a video signal output from an analog broadcasting reception unit 31 and an input video signal is selected by a switch 23. The selected video signal is digitized as a digital baseband signal (YUV) by a video decoder circuit 33 and supplied to a backend processor 34. On the other hand, a digital video signal received by a digital broadcasting reception unit 35 is demodulated by an MPEG2-TS decoder circuit 36 and supplied to the backend processor 34.

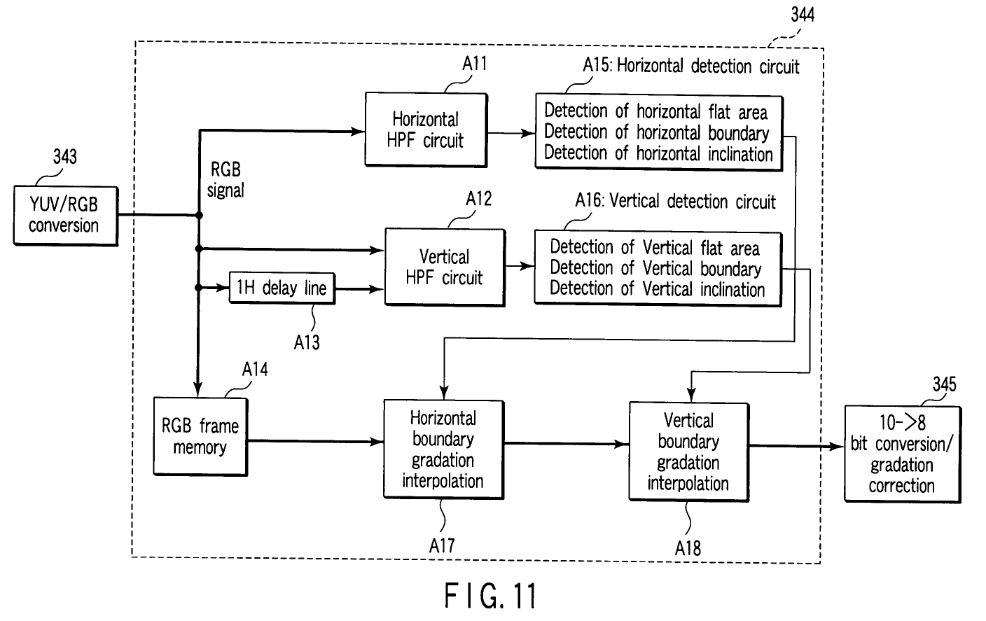

In the backend processor 34, a scaler circuit 341 adjusts the image size of each of the video signals, an image quality control circuit 342 controls the image quality thereof, a YUV-RGB conversion circuit 343 converts each of the video signals into an RGB signal, and a gradation processing circuit 344 corrects a difference in gradation level. Finally, a bit conversion/gradation correction circuit 345 subtracts two bits from each of the video signals and then the gradation of each of the signals is corrected by frame rate control (FRC). The gradation-corrected signals are converted to analog signals by a D/A conversion unit 37 and then transmitted to a display unit 23. The gradation processing circuit 344 is arranged as shown in FIG. 11. Since this arrangement is the same as that of the circuit shown in FIG. 3, the same components are denoted by the same reference numerals and their descriptions are omitted.

In the foregoing television receiver, the backend processor 34 processes 10-bit video signals and converts them into 8-bit video signals in the final stage, thereby correcting their gradations. The maximum limit value of the gradations is ten bits. In the backend processor 34, the gradation processing circuit 344 is arranged before the bit conversion/gradation correction circuit 345 in the final stage to detect a difference in level in a gradation area (boundary) and subject the boundary to dithering as shown in FIG. 8. Thus, the boundary is represented by 12-bit video signals to make the difference in level inconspicuous, with the result that a very smooth gradation can be displayed visually.

In the second embodiment, too, gradation is processed by the RGB signal. Needless to say, the same advantage can be obtained even though it is done by a YUV signal.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
a horizontal-direction processing unit which processes a frame image of a quantized video signal in a horizontal direction; and
a vertical-direction processing unit which processes the frame image of the quantized video signal in a vertical direction,
the horizontal-direction processing unit including:
horizontal filter means for receiving adjacent pixels in the horizontal direction of the frame image in sequence and outputting the pixels;
first area detection means for detecting an area in a fixed range within which values of the pixels output from the horizontal filter means fall;
first determination means for determining that a boundary in the horizontal direction is a difference in level in a gradation area when the values of the pixels output from the horizontal filter means fall within a prescribed range in the area detected by the first area detection means; and
first gradation correction means for correcting gradation before and after the boundary in the horizontal direction when the first determination means determines that the boundary is a difference in level in the gradation area, and
the vertical-direction processing unit including:
vertical filter means for receiving adjacent pixels in the vertical direction of the frame image in sequence and outputting the pixels;
second area detection means for detecting an area in a fixed range within which values of the pixels output from the vertical filter means fall;
second determination means for determining that a boundary in the vertical direction is a difference in level in a gradation area when the values of the pixels output from the vertical filter means fall within a prescribed range in the area detected by the second area detection means; and
second gradation correction means for correcting gradation before and after the boundary in the vertical direction when the second determination means determines that the boundary is a difference in level in the gradation area.

2. The video signal processing apparatus according to claim 1, wherein the first gradation correction means subjects the pixels to dithering before and after the boundary.

3. The video signal processing apparatus according to claim 1, wherein the second gradation correction means subjects the pixels to dithering before and after the boundary.

4. The video signal processing apparatus according to claim 2, wherein the dithering is performed on a basis of a difference in the values of the pixels before and after the boundary.

5. The video signal processing apparatus according to claim 3, wherein the dithering is performed on a basis of a difference in the values of the pixels before and after the boundary.

6. The video signal processing apparatus according to claim 2, wherein the dithering is performed on a basis of a degree of variation in the values of the pixels before and after the boundary.

7. The video signal processing apparatus according to claim 3, wherein the dithering is performed on a basis of a degree of variation in the values of the pixels before and after the boundary.

8. The video signal processing apparatus according to claim 2, wherein the dithering is performed before a bit conversion/gradation correcting process in a final stage.

9. The video signal processing apparatus according to claim 3, wherein the dithering is performed before a bit conversion/gradation correcting process in a final stage.

10. A method of detecting a difference in gradation level, which is applied to a video signal processing apparatus which performs horizontal-direction image processing for processing a frame image of a quantized video signal in a horizontal direction and vertical-direction image processing for processing a frame image of a quantized video signal in a vertical direction,
the horizontal-direction image processing comprising:
a horizontal filter processing step of receiving adjacent pixels in the horizontal direction of the frame image in sequence and outputting the pixels;
a first area detection step of detecting an area in a fixed range within which values of the output pixels of the horizontal filter processing step fall; and
a first determination step of determining that a boundary in the horizontal direction is a difference in level in a gradation area when the values of the output pixels of the horizontal filter processing step fall within a prescribed range in the area detected in the first area detection step, and
the vertical-direction image processing including:
a vertical filter processing step of receiving adjacent pixels in the vertical direction of the frame image in sequence and outputting the pixels;
a second area detection step of detecting an area in a fixed range within which values of the output pixels of the vertical filter processing step fall; and
a second determination step of determining that a boundary in the vertical direction is a difference in level in a gradation area when the values of the output pixels of the vertical filter processing step fall within a prescribed range in the area detected in the second area detection step.

11. The method according to claim 10, wherein the pixels are subjected to dithering in the boundary corresponding to the difference in level in the gradation area.

12. The method according to claim 10, wherein the boundary is displayed by 12-bit pixels.

13. The method according to claim 11, wherein the dithering is performed before a bit conversion/gradation correcting process in a final stage.
